(19) United States
(12) Patent Application Publication
(10) Pub. No.: US 2025/0222899 A1
(43) Pub. Date: Jul. 10, 2025

(54) WIPER DEVICE, SENSOR SYSTEM, AND VEHICLE

(71) Applicant: Robert Bosch GmbH, Stuttgart (DE)

(72) Inventors: Akos Hegyi, Mezöhegyes (HU); Bence Balint, Monor (HU); Janos Simonovics, Dunaharaszti (HU); Mate Hornyak, Pakozd (HU); Mihaly Nagy, Törökbálint (HU); Peter Deak, Budapest (HU); Peter Kosaras, Gyömrö (HU); Zoltan Varga, Kecskemet (HU)

(21) Appl. No.: 18/850,695

(22) PCT Filed: Mar. 14, 2023
(86) PCT No.: PCT/EP2023/056400

§ 371 Date: Sep. 25, 2024

(30) Foreign Application Priority Data
Apr. 5, 2022 (DE) 10 2022 203 364.7

(51) Int. Cl. B60S 1/34; B60S 1/44; G01S 7/481; G01S 7/497; G01S 17/931

(52) U.S. Cl. CPC B60S 1/3463; B60S 1/44; G01S 7/4813; G01S 7/497; G01S 17/931; G01S 2007/4977

(57) ABSTRACT

The invention is based on a wiper device comprising a wiper arm (20a; 20b; 20c), and comprising at least one wiper blade (18a, 18a′, 18a″) which is coupled to the wiper arm (20a; 20b; 20c) and comprises at least one wiper lip (22a, 22a′, 22a″) for wiping a surface (16a; 16b; 16c) of a protective element (14a; 14b; 14c) of a sensor device (12a), in particular of a lidar device, and comprising a wiper arm guide unit (24a) which is provided for moving the wiper arm (20a; 20b; 20c) in an at least substantially translatory manner along a guide track (50a).

It is proposed that the wiper device comprises a rotary joint (26a), by means of which the wiper blade (18a, 18a′, 18a″) is pivotably mounted on the wiper arm (20a; 20b; 20c).

### BACKGROUND

Previously proposed is a wiper device comprising a wiper arm, comprising at least one wiper blade which is coupled to the wiper arm, which blade comprises at least one wiper lip for wiping a surface of a protective element of a sensor device, in particular of a lidar device, and comprising a wiper arm guide unit which is provided for moving the wiper arm in an at least substantially translatory manner along a guide track.

### SUMMARY

The invention is based on a wiper device comprising a wiper arm, comprising at least one wiper blade which is coupled to the wiper arm, which comprises at least one wiper lip for wiping a surface of a protective element of a sensor device, in particular of a lidar device, and comprising a wiper arm guide unit which is provided for moving the wiper arm in an at least substantially translatory manner along a guide track.

It is proposed that the wiper device comprises a rotary joint, by means of which the wiper blade is pivotably mounted on the wiper arm.

The term “wiper device” is preferably intended to mean at least one part, preferably a subassembly, of a windshield wiper. The wiper device can preferably also comprise the entire windshield wiper, in particular comprising a wiper blade. The wiper device is preferably provided for use in a vehicle and on the sensor device. The wiper device, in particular as part of the windshield wiper, is preferably provided for cleaning a face, preferably a glass of the sensor device on a vehicle. The wiper device is preferably coupled to the vehicle. The term “provided” is preferably intended to mean specially designed, configured, arranged and/or equipped. The expression “object being provided for a specific function” is preferably intended to mean that the object fulfils and/or performs this specific function in at least one application and/or operating state. The term “operating state” is preferably intended to mean a state in which the wiper device is operationally ready for a wiping process and/or a wiping operation and/or is in a wiping operation in which the wiper lip of the wiper blade, in particular of the windshield wiper, is preferably guided across a glass, in particular the surface of the protective element, of the sensor device, and thereby advantageously bears on the surface. The surface of the protective element of the sensor device can be designed as part of a vehicle windshield. In particular, the protective element can be designed as part of a vehicle windshield.

The sensor device is preferably designed as a lidar device. The sensor device is in particular at least one part, preferably at least one sub-module, of at least one lidar sensor, in particular of a lidar sensor module. The sensor device can in particular also comprise the entire lidar sensor, in particular the entire lidar sensor module. The sensor device preferably comprises at least one lidar unit which comprises in particular at least one lidar sensor element. In particular, the sensor device can comprise a plurality (e.g., two, three, four, five, or the like) lidar sensor elements. The sensor device is preferably arranged on a vehicle for detecting the environment, in particular for autonomous driving. The sensor device can be arranged on construction sites for measuring buildings, for scanning 3-D contours and/or for research purposes in the laboratory. The sensor device, particularly by means of the at least one lidar sensor element, is in particular provided for detecting and/or measuring objects. The sensor device is preferably provided for use on a vehicle. The sensor device is preferably designed as a component of the vehicle. Alternatively, the sensor device can be designed as a retrofit kit for the vehicle. The sensor device is preferably provided for detecting objects in an environment of the vehicle. The sensor device, for detecting objects, is preferably coupled to the vehicle, preferably in a roof region, a front region, at least one lateral region, and/or one rear region of the vehicle. The sensor device is preferably connected to the vehicle, in particular to a computer unit, e.g. an onboard computer of the vehicle. The sensor device preferably comprises the protective element, in particular an aperture cover which in particular enables a laser beam to exit a housing of the sensor device, and which is in particular at least substantially transparent to detection wavelengths of the laser beam of the at least one lidar sensor element. The protective element is preferably designed as an aperture cover. The protective element, in particular the aperture cover, of the sensor device preferably defines the surface of the sensor device as an external face of the protective element, in particular of the aperture cover. The sensor device, in particular the protective element, preferably the aperture cover, is preferably at least partially arranged on an outer side of the vehicle. The protective element, preferably the aperture cover, preferably covers the sensor device at least partially, in particular in relation to the outside. For example, the protective element, preferably the aperture cover, is at least largely made of glass and/or a plastic. The wiper blade, in particular by means of the wiper lip, is in particular provided for mechanically cleaning, the protective element, preferably the aperture cover. The wiper lip is preferably designed to be rubber-like.

The wiper arm guide unit preferably comprises a drive unit which for cleaning the surface moves the wiper blade in a linear manner across the surface. The drive unit is preferably designed for moving the wiper blade along a path that is defined by the wiper arm guide unit. The wiper arm guide unit preferably defines a rectilinear path. The wiper device preferably comprises a connecting unit, by means of which the wiper arm and the wiper arm guide unit are releasably connected to each other. The connecting unit is preferably designed as a snap-in connection. The wiper arm and a support element of the wiper arm guide unit, in a completely assembled state, by means of at least one connection means are preferably connected to each other in a frictional and/or interlocking manner. The connection means, proceeding from two sides of the wiper arm that face away from each other, is preferably provided for mutually compressing the wiper arm and the support element. The drive unit is preferably designed for moving the wiper blade along the surface over the entire area, in particular for mechanically cleaning the entire area of the surface.

The wiper lip of the wiper blade is preferably designed to be replaceable. In particular, the wiper lip of the wiper blade can be designed to be replaceable without tools. A “longitudinal axis” of an object is to be understood in particular to signify an axis which runs parallel to a longest edge of a smallest geometric cuboid which only just completely encloses the object, and preferably runs through a geometric center of the object.

The drive unit, in particular between operating states of the wiper blade, is preferably designed for moving the wiper blade to a parking position in which the wiper lip for destressing the at least one contact pressure element is in particular pushed by the contact pressure unit up to a stop, and/or in which the wiper lip is arranged at a distance from the surface. For example, the surface, in particular the protective element, can be designed to taper on at least one side. In particular the protective element, in particular the aperture cover, can comprise at least one ramp element on at least one side, in particular on at least two, preferably mutually opposite, sides. For wiping from the parking position, the drive unit can, e.g., be designed for moving the wiper blade by way of the at least one ramp element onto the surface, in particular onto the protective element. For wiping from the surface, the drive unit can, e.g., be designed for moving the wiper blade from the surface to the parking position by way of the at least one ramp element.

The wiper device preferably comprises exactly one wiper arm. The wiper lip is preferably arranged, in particular largely, in the wiper arm. A longitudinal axis of the at least one wiper arm is preferably oriented parallel to the at least one surface. A longitudinal axis of the at least one wiper arm is preferably oriented parallel to an external edge of the at least one surface. The at least one surface is preferably designed to be at least substantially rectangular. The at least one wiper arm preferably extends across at least one edge length of the at least one surface. The at least one wiper arm, on at least one end of an extent of the at least one wiper arm along the longitudinal axis of the at least one wiper arm, is preferably connected to the drive unit. Alternatively, the at least one wiper arm, at both ends of the extent of the at least one wiper arm along the longitudinal axis of the at least one wiper arm, can be connected to the drive unit. The at least one wiper arm is preferably designed as an in particular metal strip which, in a cross-section perpendicular to the longitudinal axis of the at least one wiper arm, is a U-shaped strip. The at least one wiper arm preferably has a U-shaped profile, in particular in terms of the cross-section perpendicular to the longitudinal axis of the at least one wiper arm. The at least one wiper arm is preferably designed to be at least substantially cuboid. The at least one wiper arm preferably delimits a wiper cavity, the wiper lip being largely arranged in the latter. Preferably, one open side of the wiper arm, particularly in relation to the U-shaped profile, faces the surface. Preferably, the drive unit is permanently connected to the vehicle or the sensor device. Preferably, the at least one wiper arm is permanently connected to the drive unit. The contact pressure unit is preferably designed for pressing the wiper lip against the at least one wiper arm, in particular against the drive unit, and onto the surface, in particular against the vehicle, in particular against the sensor device. For purposes of regulating the contact pressure, it is conceivable for the wiper device to comprise a linear guide unit which mounts the wiper lip to be movable on the wiper arm.

The wiper blade, by way of the rotary joint, is preferably coupled to the wiper arm to be releasable without tools. The wiper blade is preferably connected to the wiper arm exclusively at the rotary joint. The rotary joint preferably mounts the wiper blade to be pivotable about a rotation axis on the wiper arm. The rotation axis is preferably oriented perpendicular to the longitudinal axis of the wiper arm. The rotation axis is preferably oriented perpendicular to a longitudinal axis of the wiper blade. The rotation axis is preferably oriented parallel to the surface. The rotation axis is preferably oriented parallel to at least one external edge of the surface. The rotation axis is preferably oriented perpendicular to the longitudinal axis of the wiper lip. The rotary joint can, e.g., comprise a bearing pin which is fixedly connected to the wiper arm. Alternatively, the rotary joint can comprise a cavity, into which the wiper blade can be suspended. The wiper blade preferably comprises an interlocking element which has a shape corresponding to that of the bearing pin or of the cavity. The wiper device can comprise a locking unit which is provided for captively connecting the wiper blade to the wiper arm, said wiper blade being pivotably mounted by way of the rotary joint. The rotary joint is preferably at least largely arranged in the wiper cavity.

Reliable cleaning of the window element can be achieved as a result of the embodiment of the wiper device according to the invention. Advantageous properties in terms of the reliability of the sensor device to be cleaned can be achieved in particular. An advantageously high safety standard for operating the sensor device for detecting objects can be achieved in particular. Travel of the vehicle can in particular be utilized for an advantageously forceful cleaning of the sensor device.

It is further proposed that the rotary joint, when viewed along a longitudinal axis of the wiper arm, is arranged to be at least substantially in a center of the wiper arm. When viewed along the longitudinal axis of the wiper arm, the rotary joint is preferably arranged exactly in a center of the wiper arm. When viewed along the longitudinal axis of the wiper arm, the rotary joint can be arranged about the center of the wiper arm in a range of at most 25%, preferably at most 10%, of the maximum extent of the wiper arm along the longitudinal axis thereof. An advantageously uniform bearing of the wiper lip on the surface can be achieved, whereby the wiper lip can advantageously slide across uneven spots on the surface.

It is further proposed that the wiper device comprises at least one contact pressure unit comprising at least one spring element which is provided for generating a contact pressure force for pressing the wiper lip onto the surface of the protective element. The wiper device preferably comprises the contact pressure unit for pressing the wiper lip onto the surface. For cleaning the surface, the drive unit is preferably designed for moving the wiper blade in a linear, and in particular bi-directional, manner across the surface, in particular whereby the contact pressure unit presses the wiper lip onto the surface. The contact pressure unit preferably comprises at least one basic contact pressure element. The contact pressure unit, in particular the at least one basic contact pressure element, is preferably designed for exerting a contact pressure force on the wiper lip, in particular for the wiper lip along a longitudinal axis of the wiper lip to bear in a planar manner on the surface. The contact pressure unit, in particular the at least one basic contact pressure element, is preferably designed for exerting a minimum contact pressure force on the wiper lip, in particular for pressing the wiper lip onto the surface at a uniform pressure of at least 10 N/m, preferably of at least 14 N/m, particularly preferably of at least 20 N/m. The contact pressure unit, in particular the spring element, is preferably designed to be different from a spring rail. The contact pressure unit is preferably designed for exerting a contact pressure force on the wiper lip, whereby a counterforce on the wiper arm and by the wiper arm is dissipated by way of the drive unit, and in particular by way of the sensor device, onto an object, e.g. the vehicle or a housing of the sensor device. The contact pressure unit is preferably designed to be different from a bar, in particular a metal bar, which, in particular in the unstressed state, has a curved shape such as a spring rail, in particular. The wiper blade can additionally comprise a spring rail. The contact pressure unit preferably comprises an adjustment gage which for adjusting the contact pressure force of the wiper lip on the surface is able to be assembled on the wiper arm. The contact pressure unit on a connection between the wiper arm and the drive unit preferably comprises an adjustment screw which in the direction of a normal to the surface adjustably forms a distance of the wiper arm from the surface. An advantageous removal of contaminations can be achieved by an advantageously intense wiping performance. In particular, stains which are difficult to release can be removed by a force acting thereon.

It is further proposed that the wiper arm guide unit comprises a support element which is coupled to the wiper arm. A guide frame of the wiper arm guide unit is preferably non-releasably connected to the sensor device, in particular to a sensor housing. The support element is preferably non-releasably connected to the guide frame. The wiper arm is preferably able to be releasably connected to the support element. An advantageously replaceable wiper arm can be achieved. In particular, an advantageous ease of maintenance of the wiper device can be achieved.

It is further proposed that a longitudinal axis of the support element is angled to be at least substantially perpendicular to a longitudinal axis of the wiper arm, in particular of the wiper lip. In this context, the expression “substantially perpendicular” is in particular intended to mean an orientation of a direction relative to a reference direction, whereby, in particular viewed in a projection plane, the direction and the reference direction enclose an angle of 90° and the angle has a maximum deviation of in particular less than 8°, advantageously less than 5° and particularly advantageously less than 2°. Alternatively, the longitudinal axis of the support element can be angled by at least 30°, preferably at least 45°, particularly preferably at least 60°, and most particularly preferably at least 75°, in relation to a longitudinal axis of the wiper arm, in particular of the wiper lip. An advantageously uncomplicated contact pressure unit for the wiper arm can be combined with the wiper arm guide unit.

It is further proposed that the wiper arm is intended to be slid onto the support element. For example, the wiper arm can be connectable to the support element by a plug-in connection, in particular by a latching connection. Alternatively, the wiper arm can be connectable to the support element by a plug-in connection which is secured by a further plug-in connection of a further securing element. An advantageously secured and releasable connection between the wiper arm and the support element can be achieved.

It is further proposed that the wiper arm in at least one assembled state is displaceably mounted in relation to the support element along an adjustment axis. The adjustment axis is preferably oriented parallel to the longitudinal axis of the support element. The wiper arm, by way of the adjustment screw, is preferably displaceable along the adjustment axis in relation to the surface, in particular in relation to the protective element. An advantageous basic adjustment for a contact pressure force of the wiper lip on the surface can be achieved.

It is further proposed that the wiper device comprises a linear guide unit, by means of which the wiper arm is mounted on the support element in a displaceable and a translatory manner along the adjustment axis. The term “linear guide unit” is intended to mean a unit consisting of at least two guide elements that are linearly displaceable relative to each other and preferably slidingly displaceable relative to each other. In principle, it would also be conceivable for at least one of the guide elements to comprise at least one roller bearing. In a fully assembled state, the wiper arm is mounted so that it can be displaced relative to the support element by means of the linear guide unit. During an operating state, the linear guide unit supports the wiper arm so that it can be displaced along the adjustment axis in relation to the support element. The linear guide unit forms a bearing axis that forms the adjustment axis. As a result, the wiper arm can be attached to the support element in a particularly advantageous way, especially in order to provide a preload force easily.

It is further proposed that the linear guide unit comprises a slide bearing rail coupled to the support element, in which the wiper arm is mounted in a sliding manner. As a result, the linear guide unit can be designed in a particularly advantageous manner.

It is further proposed that the adjustment axis is oriented at least substantially perpendicular to the surface of the protective element. The wiper arm, in a manner perpendicular to the surface, is preferably designed to be displaceable completely along the adjustment axis. A distance of the wiper arm from the surface is preferably adjustable along the adjustment axis by the adjustment screw. An advantageously precise adjustment of the contact pressure can be achieved, whereby the wiper arm has to be moved to an advantageously minor extent.

It is further proposed that the adjustment axis is oriented at an angle between 10 degrees and 80 degrees in relation to the surface of the protective element. The adjustment axis is preferably oriented at an angle of at least 15°, preferably of at least 25°, particularly preferably of at least 35°, most particularly preferably of at least 45°, in relation to the surface of the protective element. The adjustment axis is preferably oriented at an angle of at most 80°, preferably of at most 70°, particularly preferably of at most 60°, most particularly preferably of at most 50°, in relation to the surface of the protective element. An advantageously lateral accessibility to the surface or to the wiper arm can be achieved.

It is further proposed that the wiper arm and the support element are coupled to one another by way of a dovetail connection. Alternatively, the wiper arm and the support element can be coupled to one another by way of more than one dovetail connection. An advantageously stable, yet releasable, connection between the wiper arm and the support element can be achieved.

It is further proposed that the at least one spring element is arranged in the wiper blade. The at least one spring element is preferably arranged in the wiper cavity between the wiper lip and an external wall of the wiper arm that faces away from the surface. An advantageously variable generation of contact pressure can be achieved.

It is further proposed that the wiper arm is coupled to the support element via the at least one spring element. The expression “the wiper arm is coupled to the support element via the spring element” is intended to mean that the spring element is functionally arranged between the wiper arm and the support element, i.e., that it can build up a spring force between the wiper arm and the support element. One, in particular the, spring element is preferably connected directly to the wiper arm and to the support element, in particular to exert a force on the wiper arm so as to press the wiper arm in the direction of the surface. An advantageously uncomplicated pretensioning of the wiper arm can be achieved directly when the wiper arm is connected to the support element.

Further proposed is a sensor system, in particular a lidar system, comprising at least one sensor device, in particular a lidar device, which comprises a protective element, and comprising at least one wiper device according to the invention, which is provided for wiping a surface of the protective element.

Further proposed is a vehicle comprising at least one sensor system according to the invention.

In this context, the wiper device according to the invention, the sensor system according to the invention, and/or the vehicle according to the invention are not intended to be limited to the application and embodiment described hereinabove. In particular, the wiper device according to the invention, the sensor system according to the invention, and/or the vehicle according to the invention can, in order to fulfill a functional mode described herein, comprise a number of individual elements, components, and units differing from a number specified herein. Moreover, regarding the ranges of values indicated in this disclosure, values lying within the limits specified are also intended to be considered as disclosed and usable as desired.

Further advantages follow from the subsequent description of the drawings. Multiple exemplary embodiments of the invention are illustrated in the drawings. The drawings, the description, and the disclosure contain numerous features in combination. The skilled person will appropriately also consider the features individually and combine them into additional advantageous combinations.

### BRIEF DESCRIPTION OF THE DRAWINGS

Shown are:

FIG. 1 a schematic illustration of a vehicle comprising a sensor system in a first exemplary embodiment,

FIG. 2 a schematic illustration of the sensor system and of a wiper device according to the invention in the first exemplary embodiment,

FIG. 3 a schematic illustration of the wiper device,

FIG. 4 a schematic illustration of a wiper arm of the wiper device,

FIG. 5 a schematic illustration of an alternative wiper arm of the wiper device,

FIG. 6 a schematic illustration of a further alternative wiper arm of the wiper device,

FIG. 7 a schematic sectional illustration of the wiper device,

FIG. 8 a schematic sectional illustration of the wiper arm,

FIG. 9 a schematic sectional illustration of an adjustment gauge of the wiper device,

FIG. 10 a schematic sectional illustration of a contact pressure unit of the wiper device,

FIG. 11 a schematic illustration of a connecting unit of the wiper device in the first exemplary embodiment, as a variant to FIGS. 3 and 10,

FIG. 12 a schematic sectional illustration of the connecting unit,

FIG. 13 a schematic illustration of an alternative connecting unit of the wiper device in the first exemplary embodiment, as a variant to FIGS. 11 and 12,

FIG. 14 a schematic sectional illustration of the alternative connecting unit,

FIG. 15 a schematic illustration of a wiper device according to the invention in a second exemplary embodiment, and

FIG. 16 a schematic illustration of a wiper device according to the invention in a third exemplary embodiment.

### DETAILED DESCRIPTION

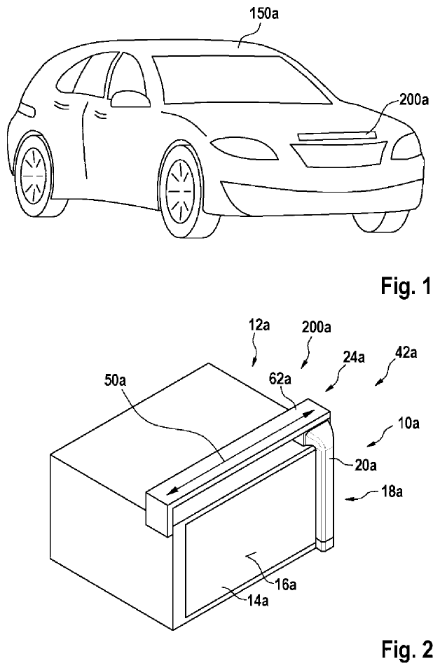

FIG. 1 shows a vehicle 150a. The vehicle 150a comprises a sensor system 200a. The sensor system 200a is designed as a lidar system. The vehicle 150a is designed as a road vehicle, in this case (by way of example) as a passenger motor vehicle.

FIG. 2 shows the sensor system 200a in abstracted form and by way of example. The sensor system 200a comprises a sensor device 12a. The sensor device 12a is designed as a lidar device. The sensor device 12a comprises a protective element 14a.

The sensor system 200a comprises a wiper device 10a. The wiper device 10a is provided for wiping a surface 16a of the protective element 14a.

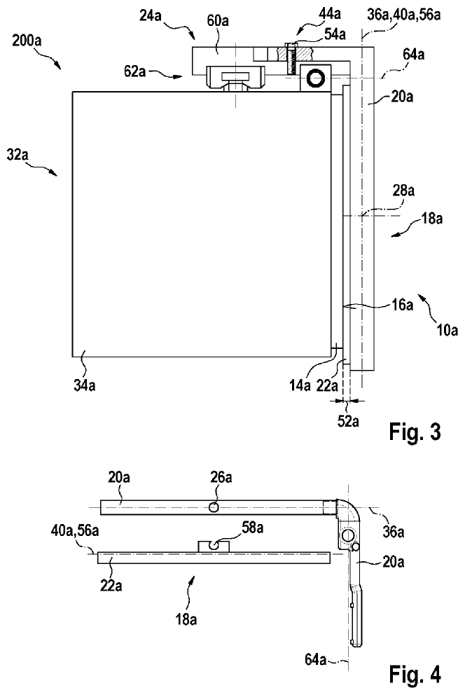

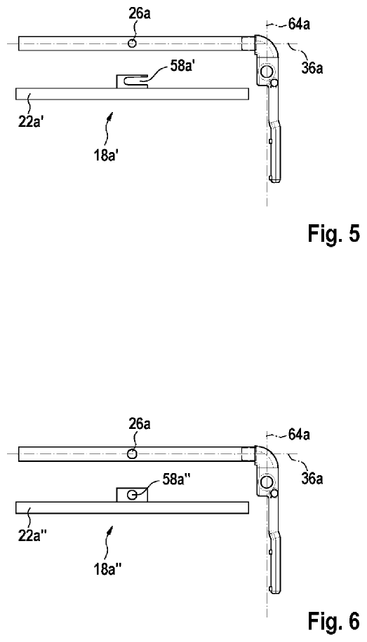

The wiper device 10a comprises a wiper blade 18a, 18a′, 18a″. The wiper blades 18a, 18a′, 18a″ shown in FIGS. 4, 5, and 6 correspond to different embodiments which, however, are able to be arranged in a similar manner on the wiper device 10a. The wiper device 10a comprises a wiper arm 20a. The wiper blade 18a, 18a′, 18a″ comprises a wiper lip 22a, 22a′, 22a″ (see FIG. 3). The wiper blade 18a, 18a′, 18a″ is coupled to the wiper arm 20a. The wiper lip 22a, 22a′, 22a″ is provided for wiping the surface 16a of the protective element 14a of the sensor device 12a, in particular the lidar device. The wiper lip 22a, 22a′, 22a″ is coupled to the wiper arm 20a. The wiper device 10a comprises a wiper arm guide unit 24a which is provided for moving the wiper arm 20a in an at least substantially translatory manner along a guide track 50a. The wiper device 10a comprises a rotary joint 26a by means of which the wiper blade 18a, 18a′, 18a″ is pivotably mounted on the wiper arm 20a. The wiper arm 20a can be designed in two parts. The wiper arm 20a can be divisible in particular by way of a snap-fit closure. The snap-fit closure is indicated by dashed lines in FIGS. 4, 5 and 6. In this case, one part of the wiper arm 20a that is able to be connected to the wiper blade 18a, 18a′, 18a″ is separable from a further part of the wiper arm 20a that is coupled to the support element 60a. A rapid replacement of the wiper blade 18a, 18a′, 18a″ can be performed as a result.

The sensor device 12a is designed as a lidar device. The sensor device 12a is provided for detecting and/or measuring objects. The sensor device 12a is provided for use on the vehicle 1500a. The sensor device 12a is provided for detecting and/or measuring objects, in particular for autonomous driving. The sensor device 12a is provided for detecting objects in an environment of the vehicle 150a. The sensor device 12a is designed as a component of the vehicle 150a. The sensor device 12a, in particular the protective element 14a, is arranged on an outer side of the vehicle 150a. The sensor device 12a comprises at least one lidar unit 32a. The lidar unit 32a comprises a lidar sensor element (not shown). The lidar unit 32a comprises a sensor housing 34a in which the lidar sensor element is arranged (see FIG. 3). The sensor device 12a comprises the protective element 14a which enables a laser beam of the sensor device 12a to exit the sensor housing 34a and is in particular transparent to a detection wavelength of the lidar sensor element. The protective element 14a is designed as an aperture cover. The protective element 14a partially covers the sensor device 12a in relation to the outside. The protective element 14a forms in particular a front part of the sensor housing 34a. The protective element 14a is made of glass and/or plastic, e.g. polycarbonate. The protective element 14a defines the surface 16a for the sensor device 12a as an external face of the protective element 14a designed as an aperture cover. The surface 16a is designed to be rectangular. The sensor device 12a for data transfer is connected to a computer unit, in particular of the vehicle 150a.

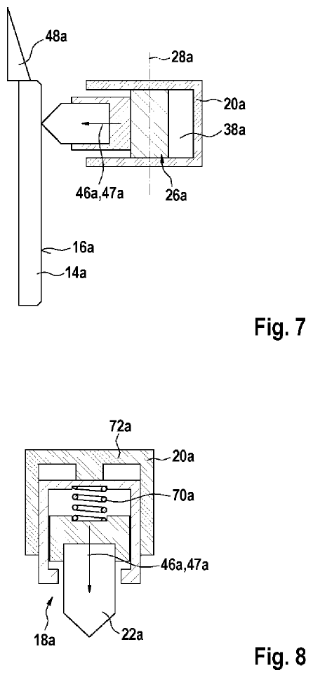

The wiper device 10a is designed for wiping the wiper device 10a. In particular, the wiper blade 18a, 18a′, 18a″, in particular by means of the wiper lip 22a, 22a′, 22a″, is provided for mechanically cleaning the protective element 14a. The wiper lip 22a, 22a′, 22a″ is designed to be rubber-like. The wiper lip 22a, 22a′, 22a″ is in particular made of a natural and/or man-made elastomer. The wiper lip 22a, 22a′, 22a″ is largely arranged in the wiper arm 20a (see FIG. 7). A longitudinal axis 36a of the wiper arm 20a is oriented parallel to the surface 16a. The wiper arm 20a extends across a shorter edge length of the rectangular surface 16a (see FIG. 2). The wiper device 10a comprises exactly one wiper arm 20a. The longitudinal axis 36a of the wiper arm 20a is oriented parallel to an external edge of the surface 16a. The surface 16a is designed to be rectangular. The wiper arm 20a extends across an edge length of the at least one surface 16a.

The wiper arm 20a is designed as a metal strip which, in a cross section perpendicular to the longitudinal axis 36a of the wiper arm 20a, is U-shaped (see FIG. 7). The wiper arm 20a has a U-shaped profile, in particular in terms of the cross section perpendicular to the longitudinal axis 36a of the wiper arm 20a. An open side, in particular in terms of the U-shaped profile, of the wiper arm 20a is oriented so as to face the surface 16a. A side of the wiper arm 20a that faces away from the surface 16a comprises in particular a flat external face. In particular, the external face of the side of the wiper arm 20a that faces away from the surface 16a is oriented parallel to the surface 16a.

The wiper arm 20a is designed in a cuboid shape (see FIGS. 1 and 2). The wiper arm 20a delimits a wiper cavity 38a in which the wiper lip 22a, 22a′, 22a″ is largely arranged. The wiper lip 22a, 22a′, 22a″ is pivotably mounted in the wiper cavity 38a (see FIGS. 4 to 6).

The wiper arm guide unit 24a comprises a drive unit 42a which, for cleaning the surface 16a, moves the wiper blade 18a, 18a′, 18a″ in a linear manner across the surface 16a. The drive unit 42a is designed for moving the wiper blade 18a, 18a′, 18a″ along the guide track 50a, the latter being defined by the wiper arm guide unit 24a. The wiper arm guide unit 24a defines a rectilinear path, in particular a rectilinear guide track 50a. The wiper arm 20a is connected to the drive unit 42a. For wiping, the wiper blade 18a, 18a′, 18a″ is guided across the surface 16a by a drive unit 42a. The drive unit 42a is designed for moving the wiper blade 18a, 18a′, 18a″ over the entire area along the surface 16a, in particular so as to mechanically clean the entire area of the surface 16a, whereby the expression “over the entire area” is intended to mean in particular that the wiper lip 22a, 22a′, 22a″ bears along the longitudinal axis 40a of the wiper lip 22a, 22a′, 22a″. The wiper arm guide unit 24a, in particular the drive unit 42a, is fixedly connected to the sensor system 200a. The sensor system 200a is fixedly connected to the vehicle 150a. The wiper arm 20a, at an end of an extent of the wiper arm 20a along the longitudinal axis 36a of the wiper arm 20a, is connected to the drive unit 42a. For cleaning the surface 16a, the drive unit 42a is designed for moving the wiper blade 18a, 18a′, 18a″ in a linear, and in particular bidirectional, manner across the surface 16a, whereby a contact pressure unit 44a presses the wiper lip 22a, 22a′, 22a″ onto the surface 16a (see FIG. 3).

Part of the contact pressure unit 44a is designed as an adjustment screw 54a on a connection between the wiper arm 20a and the drive unit 42a, said adjustment screw 54a forming an adjustable distance 52a of the wiper arm 20a from the surface 16a in the direction of a normal of the surface 16a. A basic value for the contact pressure 46a of the wiper lip 22a, 22a′, 22a″ on the surface 16a is adjustable by the contact pressure unit 44a (see FIG. 7). The contact pressure unit 44a, by means of the drive unit 42a, is designed for pressing the wiper lip 22a, 22a′, 22a″ by way of the wiper arm 20a against the vehicle 150a onto the surface 16a. The contact pressure unit 44a is designed for exerting a contact pressure force 47a on the wiper lip 22a, 22a′, 22a″, in particular for the wiper lip 22a, 22a′, 22a″ along a longitudinal axis 40a of the wiper lip 22a, 22a′, 22a″ to bear in a planar manner on the surface 16a. The wiper device 10a comprises the contact pressure unit 44a. The contact pressure unit 44a is designed for exerting a minimum contact pressure force on the wiper lip 22a, 22a′, 22a″, in particular for pressing the wiper lip 22a, 22a′, 22a″ onto the surface 16a, at a uniform pressure of at least 10 N/m, preferably of at least 14 N/m.

The wiper device 10a comprises the contact pressure unit 44a for pressing the wiper lip 22a, 22a′, 22a″ onto the surface 16.

The contact pressure unit 44a is designed for exerting a contact pressure force 47a on the wiper lip 22a, 22a′, 22a″, whereby a counterforce on the wiper arm 20a, and from the wiper arm 20a is dissipated by way of the drive unit 42a, and in particular by way of the sensor device 12a, onto an object, e.g. the vehicle 150a or a housing of the sensor device 12a.

The drive unit 42a is designed for moving the wiper blade 18a, 18a′, 18a″, in particular between operating states of the wiper blade 18a, 18a′, 18a″, to a parking position in which the wiper lip 22a, 22a′, 22a″ is arranged at a distance from the surface 16a. The protective element 14a on one side comprises a ramp element 48a (see FIG. 7). For wiping from the parking position, the drive unit 42a is designed for moving the wiper blade 18a, 18a′, 18a″ by way of the ramp element 48a onto the surface 16a. For stopping the wiping action of the surface 16a, the drive unit 42a is designed for moving the wiper blade 18a, 18a′, 18a″ from the surface 16a to the parking position by way of the ramp element 48a.

The wiper blade 18a, 18a′, 18a″ is designed to be replaceable (see FIGS. 4 to 6). In particular, the wiper blade 18a, 18a′, 18a″ is designed to be replaceable without tools. The wiper arm 20a is designed to be able to be electrically heated. The side of the wiper arm 20a that faces away toward the surface 16a of the protective element 14a is designed to be at least substantially rectangular. The side of the wiper arm 20a that faces away toward the surface 16a of the protective element 14a is designed to be at least substantially flat.

The wiper blade 18a, 18a′, 18a″ by way of the rotary joint 26a is coupled to the wiper arm 20a to be releasable without tools (see FIGS. 4 to 6). The wiper blade 18a, 18a′, 18a″ is only connected to the wiper arm 20a at the rotary joint 26a. The rotary joint 26a supports the wiper blade 18a, 18a′, 18a″ on the wiper arm 20a to be pivotable about a rotation axis 28a. The rotary joint 26a is designed as a bearing pin. The rotary joint 26a designed as a bearing pin, and when viewed perpendicularly to the longitudinal axis thereof, has a circular cross section. The rotary joint 26a designed as a bearing pin forms the rotation axis 28a. The rotation axis 28a is oriented perpendicular to the longitudinal axis 36a of the wiper arm 20a.

The rotation axis 28a is oriented perpendicular to a longitudinal axis 56a of the wiper blade 18a, 18a′, 18a″. The rotation axis 28a is oriented parallel to the surface 16a. The rotation axis 28a is oriented parallel to an external edge of the surface 16a. The rotation axis 28a is oriented perpendicular to the longitudinal axis 40a of the wiper lip 22a, 22a′, 22a″.

The wiper blade 18a, 18a′, 18a″ preferably comprises an interlocking element 58a, 58a′, 58a″ which has a shape that corresponds to that of the bearing pin. The interlocking element 58a, 58a′, 58a″ delimits a cavity for receiving the rotary joint 26a. The interlocking element 58a, 58a′, 58a″ is centrically connected to the wiper lip 22a, 22a′, 22a″. The rotary joint 26a is arranged in the wiper cavity 38a.

The rotary joint 26a, when viewed along the longitudinal axis 36a of the wiper arm 20a, is arranged to be at least substantially in a center of the wiper arm 20a. The rotary joint 26a, when viewed along the longitudinal axis 36a of the wiper arm 20a, is arranged to be exactly in the center of the wiper arm 20a. The rotary joint 26a, when viewed along the longitudinal axis 36a of the wiper arm 20a, is arranged about the center of the wiper arm 20a in a range of at most 25% of the maximum extent of the wiper arm 20a along the longitudinal axis 36a thereof (see FIGS. 4 to 6).

The wiper arm guide unit 24a comprises a support element 60a. The support element 60a is coupled to the wiper arm 20a. A guide frame 62a of the wiper arm guide unit 24a is non-releasably connected to the sensor device 12a, in particular to the sensor housing 34a. The support element 60a is non-releasably connected to the guide frame 62a. The support element 60a is movably mounted by way of the guide frame 62a. The wiper arm 20a is releasably connected to the support element 60a.

A longitudinal axis of the support element 60a is angled to be perpendicular to the longitudinal axis 36a, 40a of the wiper arm 20a, in particular of the wiper lip 22a, 22a′, 22a″. In principle, the longitudinal axis of the support element 60a could also be arranged at an angle of 30 to 90 degrees in relation to the longitudinal axis 36a of the wiper arm 20a.

The wiper arm 20a is provided for push-fitting onto the support element 60a. For example, the wiper arm 20a is connectable to the support element 60a by a plug-in connection and/or a snap connection, in particular by a latching connection.

The wiper arm 20a in at least one assembled state is displaceably mounted in relation to the support element 60a along an adjustment axis 64a. The adjustment axis 64a is oriented parallel to the longitudinal axis of the support element 60a. The wiper arm 20a, by way of the adjustment screw 54a, is displaceable along the adjustment axis 64a in relation to the surface 16a, in particular in relation to the protective element 14a. The adjustment axis 64a is oriented perpendicular to the surface 16a of the protective element 14a. The wiper arm 20a is designed to be completely displaceable along the adjustment axis 64a in relation to the surface 16a. The distance 52a of the wiper arm 20a from the surface 16a is adjustable along the adjustment axis 64a by the adjustment screw 54a (see FIG. 3).

The wiper arm 20a and the support element 60a are coupled to one another by way of a dovetail connection (see FIG. 10). The wiper arm 20a, by way of the dovetail connection, is mounted on the support element 60a so as to have one translatory degree of freedom.

The contact pressure unit 44a at a connection between the wiper arm 20a and the

drive unit 42a comprises the adjustment screw 54a which forms a distance 52a of the wiper arm 20a from the surface 16a to be adjustable in the direction of a normal of the surface 16a.

FIG. 8 shows a cross section of the wiper arm 20a. The contact pressure unit 44a comprises a spring element 70a. The spring element 70a is designed for generating a contact pressure force 47a for pressing the wiper lip 22a onto the surface 16a of the protective element 14a. The spring element 70a is arranged in the wiper arm 20a. The spring element 70a is arranged in the wiper blade 18a. The wiper blade 18a is larger arranged in the wiper arm 20a. The spring element 70a is arranged in the wiper cavity 38a between the wiper lip 22a and an external wall 72a of the wiper arm 20a that faces away from the surface 16a. In an alternative embodiment it would also be conceivable for the wiper blade 18a instead of the spring element 70a to be at least partially made of a spring steel, the latter pressing the wiper blade 18a, in particular the wiper lip 22a, against the surface 16a.

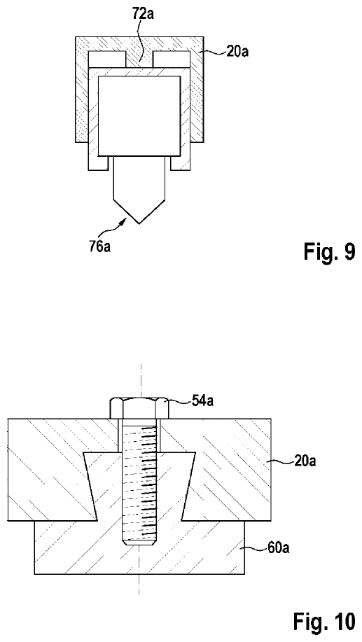

The contact pressure unit 44a comprises an adjustment gauge 76a for adjusting the contact pressure force 47a of the wiper lip 22a, 22a′, 22a″ on the surface 16a is able to be assembled on the wiper arm 20a. The adjustment gauge 76a assembled in the wiper arm 20a is shown in FIG. 9. The adjustment gauge 76a is largely arranged in the wiper arm 20a. The adjustment gauge 76a bears largely on an external wall 72a of the wiper arm 20a that faces away from the surface 16a. The adjustment gauge 76a is at least partially formed from an element which, at least in a sub-region, has the same shape as the wiper lip 22a, 22a′, 22a″. For adjusting the distance 52a, the adjustment gauge 76a instead of the wiper blade 18a, 18a′, 18a″ can be assembled on the wiper arm 20a. Once the distance 52a has been adjusted, the adjustment gauge 76a can be replaced by the wiper blade 18a, 18a′, 18a″.

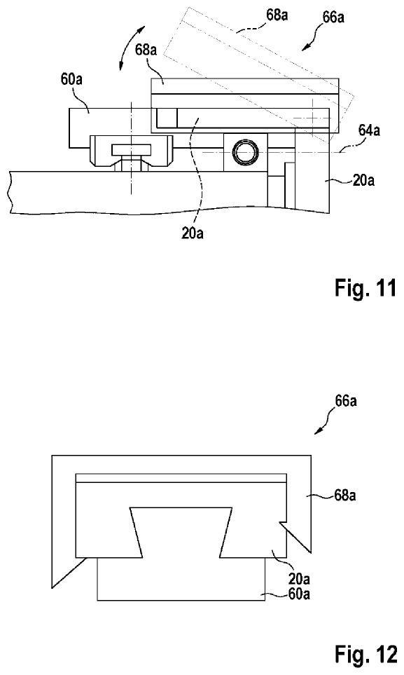

Alternatively, the wiper device 10a by means of the adjustment screw 54a can be attached to the support element 60a. The wiper device 10a comprises a connecting unit 66a by means of which the wiper arm 20a and the wiper arm guide unit 24a are releasably connected to one another. The connecting unit 66a is designed as a snap-in connection. The wiper arm 20a and the support element 60a, in a completely assembled state, by means of a connection means 68a are connected to one another in a frictional and/or interlocking manner. The connection means 68a, proceeding from two sides of the wiper arm 20a that face away from one another, is provided for mutually compressing the wiper arm 20a and the support element 60a. The connection means 68a latches onto the support element 60a and presses the support element 60a against the wiper arm 20a. The connection means 68a is pivotably mounted on the support element 60a (see FIG. 11 and FIG. 12).

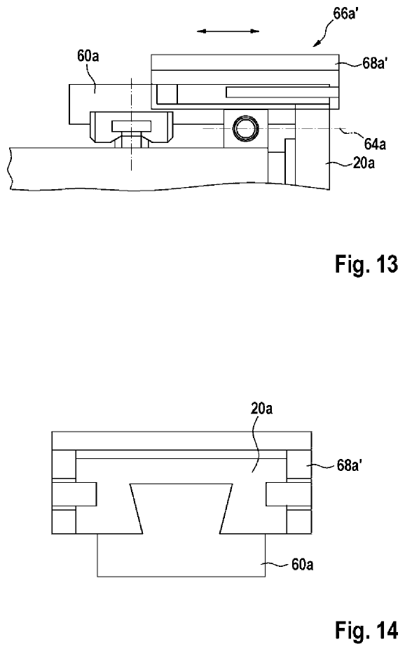

An alternative connecting unit 66a′ of the wiper device 10a is shown in FIGS. 13 and 14. The connecting unit 66a′ comprises a connection means 68a′ which for fixing a dovetail connection between the wiper arm 20a and the support element 60a engages laterally in the support element 60a. The connection means 68a′ is able to be slid onto the wiper arm 20a in a translatory manner parallel to the adjustment axis 64a. The connection means 68a′, proceeding from two sides of the wiper arm 20a that face away from one another, is provided for mutually compressing the wiper arm 20a and the support element 60a. The connection means 68a′ latches onto the support element 60a and presses the support element 60a against the wiper arm 20a.

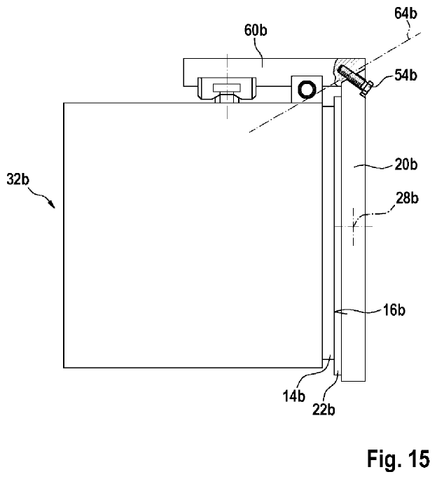

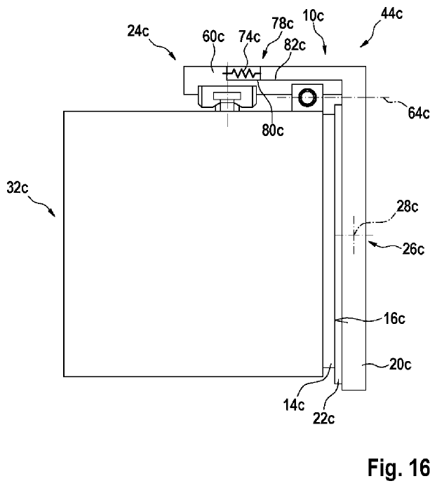

Two further exemplary embodiments of the invention are shown in each of FIGS. 15 and 16. The following descriptions and the drawings are essentially limited to the differences between the exemplary embodiments, whereby reference can, in principle, also be made, with respect to identically designated components, in particular with respect to components having the same reference numbers, to the drawings and/or the description of the other exemplary embodiments, in particular FIGS. 1 to 14. In order to distinguish between the exemplary embodiments, the letter a is appended to the reference characters for the exemplary embodiment in FIGS. 1 to 14. The letter a is replaced by the letters b and c in the exemplary embodiments in FIGS. 15 and 16.

An alternative wiper device 10b is shown in FIG. 15. As opposed to the first exemplary embodiment, an adjustment axis 64b is oriented in a different manner. The adjustment axis 64b is oriented at an angle between 10° and 80°, in particular at an angle of 33°, in relation to a surface 16b of the protective element 14b. A connection between the wiper arm 20b and the support element 60b can be established as in the first exemplary embodiment.

A further alternative wiper device 10c is shown in FIG. 16. The wiper device 10c comprises a wiper blade 18c and a wiper arm 20c. The wiper blade 18c comprises a wiper lip 22c. The wiper blade 18c is coupled to the wiper arm 20c. The wiper device 10c comprises a contact pressure unit 44c. As opposed to the preceding exemplary embodiments, the wiper arm 20c, in particular in the assembled state, is mounted so as to slide in relation to a support element 60c. The wiper device 10c comprises a linear guide unit 78c. By means of the linear guide unit 78c, the wiper arm 20c is mounted on the support element 60c to be displaceable in a translatory manner along an adjustment axis 64c. The linear guide unit 78c comprises a slide bearing rail 80c coupled to the support element 60c. The slide bearing rail 80c is preferably designed to be integral with the support element 60c. The slide bearing rail 80c is preferably formed by the support element 60c. The slide bearing rail 80c is provided so that the wiper arm 20c is slidingly mounted thereon. The linear guide unit 78c comprises a slide bearing element 82c designed to correspond to the slide bearing rail 80c, which is coupled to the wiper arm 20c. The slide bearing element 82c is preferably designed to be integral with the wiper arm 20c. The wiper arm 20c is displaceably mounted on the slide bearing rail 82c relative to the support element 60c via the slide bearing element 82c. The linear guide unit 78c forms a bearing axis along which the slide bearing element 82c is displaceably mounted on the slide bearing rail 80c. The bearing axis is coaxial to the adjustment axis 64c. The linear guide unit 78c is oriented such that a bearing axis and thus the adjustment axis 64c is oriented orthogonally to a surface of a protective element of a sensor device to be wiped.

The wiper arm 20c is coupled to the support element 60c via a spring element 74c of the contact pressure unit 44c. The spring element 74c is connected directly to the wiper arm 20c and to the support element 60c. The spring element 74c is operatively arranged between the wiper arm 20c and the support element 60c. The spring element 74c impinges the wiper arm 20c with a contact pressure force 47c on the surface 16c. The wiper arm 20c, in a translatory manner, is mounted on the support element 60c so as to slide along an adjustment axis 64c. The wiper arm 20c is attached to the support element 60c so that it can be displaced in a translatory manner via the linear guide unit 78c. The spring element 74c is designed as a tension spring. The spring element 74c is provided to pull the wiper arm 20c along the adjustment axis 64c, preferably toward the support element 60c. Due to the displaceable mounting of the wiper arm 20c by means of the linear guide unit 78c and the spring force of the spring element 74c of the contact pressure unit 44c, the wiper arm 20c and thus a wiper lip 22c connected to the wiper blade 18c is pressed against a surface 16c to be wiped.

The wiper device 10c comprises a rotary joint 26c, by means of which the wiper blade 18c is pivotably mounted on the wiper arm 20c. The rotary joint 26c forms a rotation axis 28c about which the wiper blade 18c is mounted to be rotatable relative to the wiper arm 20c. Due to the rotary joint 26c, the wiper blade 18c has a rotational degree of freedom relative to the wiper arm 20c. As a result, a slight inclination between the wiper device 10c, in particular the wiper arm 20c and the surface 16c being wiped can be compensated for. As a result, component tolerances, signs of wear, and environmental influences in particular are able to be compensated for.

1. A wiper device comprising a wiper arm (20a; 20b; 20c), and comprising at least one wiper blade (18a, 18a′, 18a″) which is coupled to the wiper arm (20a; 20b; 20c) and comprises at least one wiper lip (22a, 22a′, 22a″) for wiping a surface (16a; 16b; 16c) of a protective element (14a; 14b; 14c) of a sensor device (12a), and comprising a wiper arm guide unit (24a) which is provided for moving the wiper arm (20a; 20b; 20c) in an at least substantially translatory manner along a guide track (50a), further comprising a rotary joint (26a), by means of which the wiper blade (18a, 18a′, 18a″) is pivotably mounted on the wiper arm (20a; 20b; 20c).

2. The wiper device according to claim 1, wherein the rotary joint (26a), when viewed along a longitudinal axis (36a) of the wiper arm (20a; 20b; 20c), is arranged at least substantially in a center of the wiper arm (20a; 20b; 20c).

3. The wiper device according to claim 1, wherein at least one contact pressure unit (44a) comprising at least one spring element (70a; 74c), which is provided for generating a contact pressure force (47a) to press the wiper lip (22a, 22a′, 22a″) onto the surface (16a; 16b; 16c) of the protective element (14a; 14b; 14c).

4. The wiper device according to claim 1, wherein the wiper arm guide unit (24a) comprises a support element (60a; 60b; 60c) which is coupled to the wiper arm (20a; 20b; 20c).

5. The wiper device according to claim 4, wherein a longitudinal axis of the support element (60a; 60b; 60c) is angled at least substantially perpendicular to a longitudinal axis (36a) of the wiper arm (20a; 20b; 20c).

6. The wiper device according to claim 4, wherein the wiper arm (20a; 20b; 20c) is intended to be slid onto the support element (60a; 60b; 60c).

7. The wiper device according to claim 4, the wiper arm (20a; 20b; 20c) in at least one assembled state is displaceably mounted in relation to the support element (60a; 60b; 60c) along an adjustment axis (64a; 64b; 64c).

8. The wiper device according to claim 7, further comprising a linear guide unit (78c), by which the wiper arm (20c) is mounted on the support element (60c) in a displaceable and a translatory manner along the adjustment axis (64c).

9. The wiper device according to claim 8, wherein the linear guide unit (78c), which comprises a slide bearing rail (82c) coupled to the support element (60c), in which slide bearing rail the wiper arm (20c) is displaceably mounted.

10. The wiper device according to claim 7, wherein the adjustment axis (64a; 64c) is oriented at least substantially perpendicular to the surface (16a; 16c) of the protective element (14a; 14b; 14c).

11. The wiper device according to claim 7, wherein the adjustment axis (64b) is oriented at an angle between 10 degrees and 80 degrees in relation to the surface (16b) of the protective element (14b).

12. The wiper device according to claim 4, wherein the wiper arm (20a; 20b; 20c) and the support element (60a; 60b; 60c) are coupled to one another by way of a dovetail connection.

13. The wiper device according to claim 3, wherein the at least one spring element (70a) is arranged in the wiper blade (18a, 18a′, 18a″).

14. The wiper device according to claim 3, wherein the wiper arm (20c) is coupled to the support element (60c) via the at least one spring element (74c).

15. A sensor system comprising at least one sensor device (12a), which comprises a protective element (14a), said system comprising at least one wiper device (10a; 10b; 10c) according to claim 1, which is provided for wiping a surface (16a; 16b; 16c) of the protective element (14a; 14b; 14c).

16. A vehicle comprising at least one sensor system (200a) according to claim 15.

17. The wiper device according to claim 1, wherein the sensor device (12a) is a lidar device.

18. The wiper device according to claim 5, wherein a longitudinal axis of the support element (60a; 60b; 60c) is angled at least substantially perpendicular to a longitudinal axis (36a) of the wiper lip (22a; 22a′; 22a″).

19. The sensor system according to claim 15, wherein the at least one sensor device (12a) is a lidar device.
